(19) United States
(12) Patent Application Publication
(10) Pub. No.: US 2024/0218106 A1
(43) Pub. Date: Jul. 4, 2024

(54) POLYURETHANE, ROLLER COVERING AND PRODUCTION METHOD

(71) Applicant: Voith Patent GmbH, Heidenheim (DE)

(72) Inventors: Anton Horak, Wien (AT); Stefan Pollaschek, Traiskirchen (AT)

(21) Appl. No.: 18/556,147

(22) PCT Filed: Feb. 8, 2022
(86) PCT No.: PCT/EP2022/052970

§ 371 Date: Oct. 19, 2023

(30) Foreign Application Priority Data
Apr. 19, 2021 (DE) 10 2021 109 750.9

(51) Int. Cl. C08G 18/10; C08G 18/44; C08K 3/04; C08K 3/36

(52) U.S. Cl. CPC C08G 18/10; C08G 18/44; C08K 3/04; C08K 3/36; C08G 2150/00; C08G 2261/76

(57) ABSTRACT

A polyurethane for producing roller covers is obtainable by reacting the following components a) at least one diisocyanate, b) at least one polycarbonate diol having a molecular weight of between 500 and 3000 and c) an additional diol. The NCO/OH ratio is between 0.9 and 0.99. A production method, a roller cover with the polyurethane and a production method for the roller cover, are also provided.

The present invention relates to polyurethane for use in a roller covering according to the preamble of claim 1, to a roller covering comprising such a polyurethane and to a production process for a polyurethane and to such a roller covering.

Industrial rollers, especially for rollers in a plant for production or processing of a paper web or other fibrous web, often consist of a completely or largely cylindrical roller core which is typically made of metal. A single- or multi-layered roller covering is then applied to this roller core. This roller covering may may be made of one or more polymers. By appropriately selecting the construction of, composition of and process for producing these coverings the properties of the roller may be adapted and optimized for the intended application.

Polyurethanes (PU) are often used for the production of these roller covers. PU rollers can be produced with very different hardnesses, from hard rollers (0 P&J) to very soft rollers with 100 P&J or softer. PU coverings are typically produced by a casting process. It is known that polyurethane coverings produced by the casting process generally have excellent mechanical properties and have a very good hydrolysis stability.

However, especially in the case of relatively soft coverings in the range of >40 P&J (Pusey & Jones) and very particularly in the range of above 60 P&J a marked reduction in these exceptional properties occurs.

These coverings are also difficult to provide with so-called functional fillers. Optimal adaptation of the properties of the roller covering is therefore not always ensured.

DE 101 51 485 proposes avoiding the casting process and producing polyurethane roller coverings in an extrusion process or using calendered plates. However, DE 101 51 485 gives a person skilled in the art only vague pointers regarding the optimal configuration of the polyurethanes used.

It is generally known, for example from U.S. Pat. No. 6,008,312, that polyurethane types include not only castable polyurethanes but also thermoplastic polyurethanes and so-called “millable” polyurethanes.

These millable PUs are advantageous for the processes described in DE 101 51 485, since they may be processed with conventional rollers, presses or other apparatuses known from rubber processing and in particular may also be applied in an extrusion process.

It is an object of the present to further develop the teaching of DE 101 51 485. It is a further object of the invention to propose a material for a roller covering which has good mechanical properties and good hydrolysis resistance.

It is especially an object of the present invention to propose a class of polyurethanes that is processable on machines as are customary in the rubber industry (kneaders, roller mills, strainers, extruders, . . . ).

The objects are especially achieved by a polyurethane according to claim 1, by a production process for a polyurethane according to claim 8, by a roller covering according to claim 7 and by a production process for a roller covering according to claim 11.

Advantageous embodiments are described in the dependent claims.

Having regard to the polyurethane the object is achieved by a polyurethane for producing roller coverings, obtainable by reacting the components
a. at least one diisocyanate,
b. at least one polycarbonate diol having a molar weight between 500 and 3000 and
c. a further diol.

According to the invention it is provided that the NCO/OH ratio is between 0.9 and 0.99, in particular between 0.9 and 0.95.

The NCO/OH ratio, i.e. the molar ratio of the NCO groups of the isocyanates to the OH groups of the polyols, and the determination thereof is well known to those skilled in the art in the field.

It is known from the literature that polyurethanes based on polycarbonate diols, such as are employed in the context of the present invention, are characterized by exceptional mechanical properties and by a high hydrolysis stability.

The inventors have recognized that it is also possible on the basis of polycarbonate diols to produce so-called “millable PU” (sometimes also referred to as “millable gum”) which may be processed on machines such as are customary in the rubber industry. This makes it possible for example to dispense with a casting process in the production of roller coverings.

The stoichiometry of the components must be strictly observed. An NCO/OH ratio of 0.90-0.99, in particular of 0.90 to 0.95, has been found to be optimal. In the event of a downward deviation the polymer is not solid enough to allow processing on a roller mill for example. However, if the NCO/OH ratio is greater than 0.99 the viscosity is so high that the mixture is also no longer processible. An NCO/OH ratio >1 results in crosslinking that precludes a processing such as is customary in the rubber industry.

Advantageous values for the NCO/OH ratio are for example 0.90, 0.91, 0.92, 0.93, 0.94, 0.95, 0.96, 0.97, 0.98 or 0.99.

It may be advantageous when the at least one polycarbonate diol is a polycarbonate diol based on pentanediol, hexanediol or 3-methyl-1,5-pentanediol.

The further diol is generally referred to as part of the hard segment. In particularly preferred embodiments it may be provided that the at least one further diol is an unsaturated glycol. This may be for example a trimethylolpropane monoallyl ether or glycerol monoallyl ether or a 1-dihydroxymethylcyclohex-3-ene or 1,2-dihydroxymethylcyclohex-4-ene. This significantly improves the crosslinkability of this millable polyurethane based on polycarbonate diol with peroxide and/or sulfur.

It is accordingly advantageous when a peroxide- or sulfur-based crosslinker is added to the polyurethane. The polyurethane may accordingly be crosslinked in a subsequent vulcanization step after application to the roller, for example by means of extrusion. This makes it possible to adapt the material properties of the finished roller covering.

The at least one diisocyanate may be selected for example from the group of methylene diphenyl isocyanate (MDI), naphthylene 1,5-diisocyanate (NDI), isophorone diisocyanate (IPDI), toluene 2,4-diisocyanate (TDI) or H12MDI. However, the invention is not limited to these diisocyanates.

Although it is often simplest to use a single polycarbonate diol with a single diisocyanate and a single further diol it should be noted here that in the case of polyurethanes according to different aspects of the present invention it is also possible to employ for example two or more different polycarbonate diols and/or diisocyanates and/or further diols.

Further substances may also be provided in addition to the components mentioned. These may include for example stabilizers such as phenolic antioxidants and/or organic phosphite. However, these usually account for no more than 1-5 parts per thousand based on the total amount.

However, the addition of amine compounds can and should be avoided.

Suitable fillers may also be added to polyurethanes according to aspects of the present invention. This allows various properties of the material but also of a roller produced therewith to be adapted quite specifically. It may especially be provided that structure-reinforcing fillers are added to the polyurethane. Structure-reinforcing fillers may, for example, include a suitable carbon black and/or a precipitated silica and/or a pyrogenic silica. The silica may be uncoated or coated with vinyltriethoxysilane for example. In the case of vulcanization with sulfur a coating with Si69 (bis[3-(triethoxysilyl)propyl] tetrasulfide) may be advantageous.

With regard to the roller covering the object is achieved by a roller covering for a roller, especially for use in a plant for producing or processing a fibrous web, characterized in that the roller covering is constructed entirely or partially from a polyurethane according to any aspect of the present invention.

Such a roller typically comprises an entirely or largely cylindrical roller core which is usually made of metal. The roller covering is applied to this roller core. The roller covering is constructed from several layers for simpler production or to achieve a suitable profile of properties. In the case of roller coverings according to aspects of the present invention it is possible for one, two or more, or all layers of a polyurethane to be constructed according to aspects of the present invention. In particular it is advantageous when the radially outermost layer which in corresponding applications is in contact with the fibrous web is produced from a polyurethane according to one aspect of the invention.

Having regard to the production process the object is achieved by a process for producing a polyurethane for production of roller coverings comprising the steps of:
a) providing at least one diisocyanate, at least one polycarbonate diol having a molar weight between 500 and 3000 and a further diol,
b) mixing the components, the amounts being selected such that the NCO/OH ratio is between 0.9 and 0.99, in particular between 0.9 and 0.95,
c) heat-treating the mixture at a temperature between 60° C. and 80° C., in particular at 70° C.

The heat-treating of the mixture is typically carried out until free isocyanate groups (NCO groups) are no longer detectable. This generally requires at least 24 h. A period between 48 h and 72 h has proven advantageous.

It may further be advantageous when the process comprises the steps of:
d) adding a peroxide-or sulfur-based crosslinker, and/or
e) adding at least one structure-reinforcing filler, in particular carbon black and/or precipitated silica and/or pyrogenic silica,
f) adding coagents, such as for example trifunctional and difunctional (meth)acrylate esters, N,N′-m-phenylenedimaleimide, zinc diacrylate, zinc dimethacrylate, poly(butadiene) diacrylate, triallyl cyanurate, triallyl isocyanurate and/or vinylpoly(butadiene). These and other suitable coagents are generally known to those skilled in the art.

The steps d) and/or e) and/or f) shall be carried out after steps a.) to c.). The crosslinkers and/or fillers and/or coagents may be added to the heat-treated polymer mixture and mixed with the polymer mixture, for example in a suitable mixing apparatus.

The present invention finally proposes a process for producing a roller covering for a roller, especially for use in a plant for producing or processing a fibrous web, comprising the steps of:
A.) producing a polyurethane according to one aspect of the invention,
B.) applying the polyurethane to a roller main body by extrusion,
C.) vulcanizing the roller in an autoclave,

Extruding this mixture makes it possible to avoid a casting process.

The subsequent vulcanizing results in crosslinking of the polymers.

The roller main body may be a roller core. Said main body may alternatively be a roller core to which one or more layers of the roller covering have already been applied.

After vulcanization the roller cover may also be subjected to mechanical processing and/or grinding. This makes it possible to produce for example a desired smoothness or surface structure.

### EXAMPLE 1

The invention shall be more particularly elucidated in the example which follows. The invention is limited neither to these materials nor to this exemplary combination or these proportions.

In advantageous embodiments it is possible to employ for example the following substances:
Polycarbonate diols/prepolymers based on polycarbonate diols, for example: Eternacoll P 200D or the prepolymers based on polycarbonate diols such as Eternathane 400-7 from UBE.
Polycarbonate prepolymers from Covestro such as for example Desmodur MZ 4610 and a polycarbonate diol such as for example Baytec C 2208.
Trimethylolpropane monoallyl ether (TMP allyl ether) as a further diol which comprises an allyl group.

The following table shows two examples that may be used for a polymer according to one aspect of the invention.

| | % by | | % by |
|---|---|---|---|
| Example 1 | wt. | Example 2 | wt. |
| Eternathane 400-7 | 47.75 | Desmodur MZ 4610 | 48.77 |
| Eternacoll P 200D | 48.98 | Baytec C 2208 | 44.10 |
| Trimethylolpropane | 3.27 | Trimethylolpropane | 7.13 |
| monoallyl ether | | monoallyl ether | |
| (TMPME) | | (TMPME) | |

The NCO/OH ratio for both examples is between 0.9 and 0.95.

The NCO/OH ratio may be controlled by adapting the proportions of the three components. The TMP allyl ether has the lowest molecular weight of all components and thus the greatest influence on the NCO/OH ratio.

The above formulations may then for example also be admixed with fillers—such as for example a suitable carbon black and/or a precipitated silica and/or a pyrogenic silica—and/or activators and/or peroxide and/or sulfur/sulfur compounds etc.

These mixtures may be used to produce extrudable mixtures.

Addition of amine compounds is not advantageous and was not carried out in the described examples.

1-11. (canceled)

12-24. (canceled)

25. A polyurethane for production of roller coverings, the polyurethane comprising a product obtainable by reaction of the following components:
a. at least one diisocyanate;
b. at least one polycarbonate diol having a molar weight between 500 and 3000; and
c. a further diol; and
an NCO/OH ratio between 0.9 and 0.99.

26. The polyurethane according to claim 25, wherein the NCO/OH ratio is between 0.9 and 0.95.

27. The polyurethane according to claim 25, wherein the at least one polycarbonate diol is a polycarbonate diol based on pentanediol, hexanediol or 3-methyl-1,5-pentanediol.

28. The polyurethane according to claim 25, wherein the further diol is an unsaturated glycol or the further diol is selected from glyceryl alpha-allyl ether, trimethylolpropane monoallyl ether, 1,1-dihydroxymethylcyclohex-3-ene or 1,2-dihydroxymethylcyclohex-4-ene.

29. The polyurethane according to claim 25, which further comprises a peroxide-based or sulfur-based crosslinker being added.

30. The polyurethane according to claim 25, wherein the at least one diisocyanate is selected from the group of methylene diphenyl isocyanate (MDI), naphthylene 1,5-diisocyanate (NDI), isophorone diisocyanate (IPDI), tolylene 2,4-diisocyanate (TDI) or H12MDI.

31. The polyurethane according to claim 25, which further comprises structure-reinforcing fillers or at least one of carbon black or precipitated silica or pyrogenic silica, being added to the polyurethane.

32. A roller covering for a roller or for a roller in a plant for producing or processing a fibrous web, the roller covering comprising:
the polyurethane according to claim 25 partially or entirely forming the roller covering.

33. A process for producing a polyurethane for production of roller coverings, the process comprising steps of:
a. providing components including at least one diisocyanate, at least one polycarbonate diol having a molar weight between 500 and 3000 and a further diol;
b. mixing the components in amounts selected to provide an NCO/OH ratio between 0.9 and 0.99; and
c. heat-treating the mixture at a temperature between 60° C. and 80° C.

34. The process according to claim 32, which further comprises carrying out the step of mixing the components in amounts selected to provide the NCO/OH ratio between 0.9 and 0.95.

35. The process according to claim 32, which further comprises carrying out the step of heat-treating the mixture at a temperature of 70° C.

36. The process according to claim 32, which further comprises a step of:
d. adding a peroxide-based or sulfur-based crosslinker after steps a. to c.

37. The process according to claim 32, which further comprises a step of:
e. adding at least one structure-reinforcing filler or at least one of carbon black or precipitated silica or pyrogenic silica, after steps a. to c.

38. A process for producing a roller covering for a roller or for a roller in a plant for producing or processing a fibrous web, the process comprising steps of:
A. producing a polyurethane according to claim 32;
B. applying the polyurethane to a roller main body by extrusion to produce a coating;
C. vulcanizing the roller in an autoclave to produce a coating; and
D. optionally mechanically processing the coating.
